(19) United States
(12) Patent Application Publication
(10) Pub. No.: US 2018/0022403 A1
(43) Pub. Date: Jan. 25, 2018

(54) METHOD FOR CONTROLLING VEHICLE DOWNFORCE

(71) Applicant: GM GLOBAL TECHNOLOGY OPERATIONS LLC, Detroit, MI (US)

(72) Inventors: JASON D. FAHLAND, FENTON, MI (US); JOSHUA R. AUDEN, BRIGHTON, MI (US); EDWARD T. HEIL, HOWELL, MI (US); DAVID DOMINGUEZ, TUCSON, AZ (US)

(73) Assignee: GM GLOBAL TECHNOLOGY OPERATIONS LLC, Detroit, MI (US)

(21) Appl. No.: 15/215,473

(22) Filed: Jul. 20, 2016

(51) Int. Cl. B62D 37/02; B60W 40/12; B60W 40/13; B62D 35/02

(52) U.S. Cl. CPC B62D 37/02; B62D 35/02; B60W 40/12; B60W 40/13; B60W 2530/20; B60W 2300/18; B60W 2300/28; B60W 2510/22; B60W 2550/142; B62D 35/005

(57) ABSTRACT

Methods, systems, and vehicles are provided for controlling downforce for vehicles. In accordance with one embodiment, a vehicle includes one or more downforce elements, one or more sensors, and a processor. The one or more sensors are configured to measure one or more parameter values for the vehicle during operation of the vehicle. The processor is coupled to the downforce elements and to the one or more sensors. The processor is configured to at least facilitate adjusting a downforce for the vehicle, during operation of the vehicle, based on the one or more parameter values, by providing instructions for controlling the one or more downforce elements.

### TECHNICAL FIELD

The present disclosure generally relates to vehicles, and more particularly relates to methods and systems for controlling downforce for vehicles.

### BACKGROUND

Certain vehicles today, such as racecars and other performance vehicles, utilize downforce for potentially improving performance. For example, certain performance vehicles utilize airfoils, wings, or other devices to generate downforce for the vehicle. An increase in downforce can enhance lateral capability for the vehicle, for example when turning a corner. However, an increase in downforce can also increase aerodynamic drag for the vehicle, for example when travelling on a straight road or track, and can also provide wear on certain vehicle components under certain conditions.

Accordingly, it is desirable to provide techniques for improved control of downforce for vehicles. It is also desirable to provide methods, systems, and vehicles incorporating such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises obtaining one or more parameter values for a vehicle during operation of the vehicle, and adjusting a downforce for the vehicle, during operation of the vehicle, based on the one or more parameter values, using instructions provided via a processor for controlling one or more downforce elements for the vehicle.

In accordance with another exemplary embodiment, a system is provided. The system comprises one or more sensors and a processor. The one or more sensors are configured to measure one or more parameter values for a vehicle during operation of the vehicle. The processor is coupled to the one or more sensors. The processor is configured to at least facilitate adjusting a downforce for the vehicle, during operation of the vehicle, based on the one or more parameter values, by providing instructions for controlling one or more downforce elements for the vehicle.

In accordance with a further exemplary embodiment, a vehicle is provided. The vehicle comprises one or more downforce elements, one or more sensors, and a processor. The one or more sensors are configured to measure one or more parameter values for the vehicle during operation of the vehicle. The processor is coupled to the downforce elements and to the one or more sensors. The processor is configured to at least facilitate adjusting a downforce for the vehicle, during operation of the vehicle, based on the one or more parameter values, by providing instructions for controlling the one or more downforce elements.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle, and that includes a control system for controlling downforce for the vehicle, in accordance with an exemplary embodiment; and

FIG. 2 is a flowchart of a process for controlling downforce for a vehicle, and that can be used in connection with the system and vehicle of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

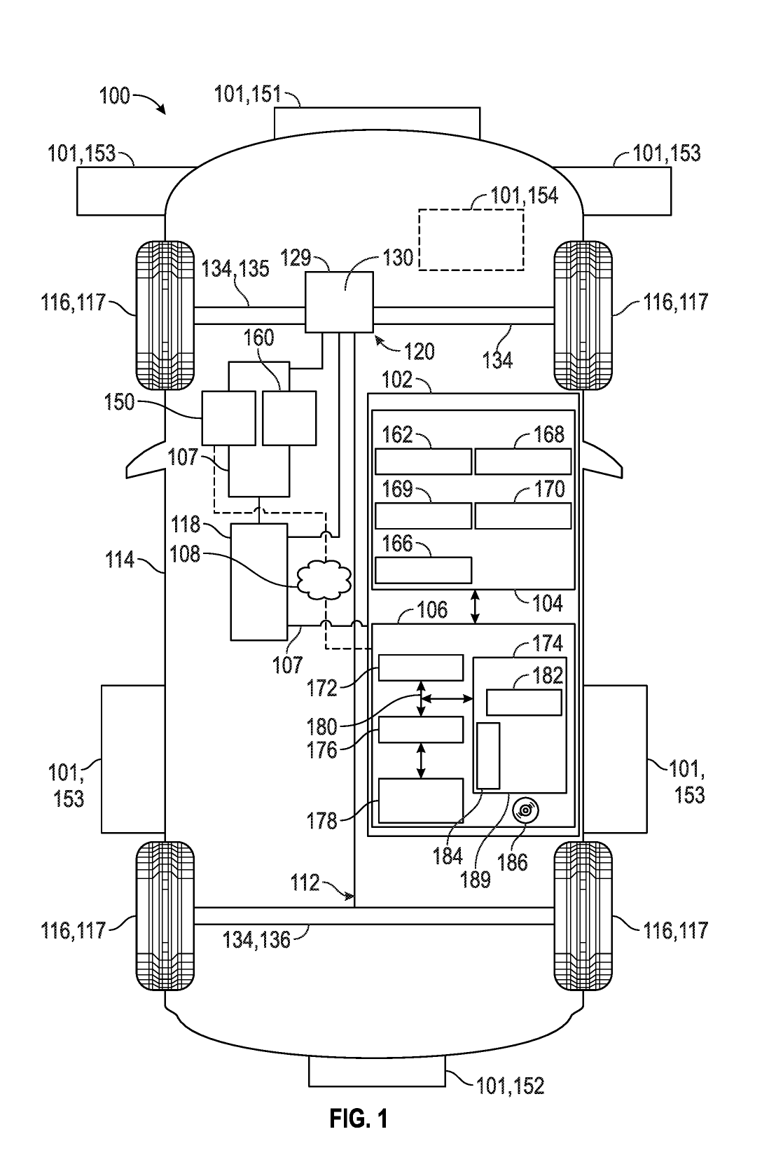

FIG. 1 illustrates a vehicle 100, according to an exemplary embodiment. As described in greater detail below, the vehicle 100 includes downforce elements 101 and a control system 102 for controlling downforce for the vehicle 100. In various embodiments the vehicle 100 comprises an automobile; however, this may vary in other embodiments. Also in certain embodiments the vehicle 100 comprises a performance vehicle, such as a racecar or other vehicle capability of relatively high performance and speed. The vehicle 100 may be any one of a number of different types of automobiles and/or other vehicles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

In one embodiment depicted in FIG. 1, the vehicle 100 includes, in addition to the above-referenced downforce elements 101 and control system 102, a chassis 112, a body 114, four wheels 116, an electronic control system (ECS) 118, a powertrain 129, a steering system 150, and a braking system 160. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. As depicted in FIG. 1, each wheel 116 comprises a wheel assembly that includes a tire 117 as well as a wheel and related components (and that are collectively referred to as the “wheel 116” at times for the purposes of this Application). In various embodiments the vehicle 100 may differ from that depicted in FIG. 1.

In the exemplary embodiment illustrated in FIG. 1, the powertrain 129 includes an actuator assembly 120 that includes an engine 130. In various other embodiments, the powertrain 129 may vary from that depicted in FIG. 1 and/or described below (e.g. in some embodiments the powertrain may include a gas combustion engine 130, while in other embodiments the powertrain 129 may include an electric motor, alone or in combination with one or more other powertrain 129 components, for example for electric vehicles, hybrid vehicles, and the like). In one embodiment depicted in FIG. 1, the actuator assembly 120 and the powertrain 129 are mounted on the chassis 112 that drives the wheels 116. In one embodiment, the engine 130 comprises a combustion engine. In various other embodiments, the engine 130 may comprise an electric motor and/or one or more other transmission system components (e.g. for an electric vehicle), instead of or in addition to the combustion engine.

Still referring to FIG. 1, in one embodiment, the engine 130 is coupled to at least some of the wheels 116 through one or more drive shafts 134 (or axles). In the depicted embodiment, front axles 135 and rear axles 136 are depicted. In some embodiments, the engine 130 is mechanically coupled to the transmission. In other embodiments, the engine 130 may instead be coupled to a generator used to power an electric motor that is mechanically coupled to the transmission. In certain other embodiments (e.g. electrical vehicles), an engine and/or transmission may not be necessary.

The steering system 150 is mounted on the chassis 112, and controls steering of the wheels 116. In various embodiments, the steering system 150 includes a steering wheel and a steering column, not depicted in FIG. 1.

The braking system 160 is mounted on the chassis 112, and provides braking for the vehicle 100. In various embodiments, the vehicle 100 automatically controls braking of the vehicle 100 via instructions provided from the control system 102 to the braking system 160.

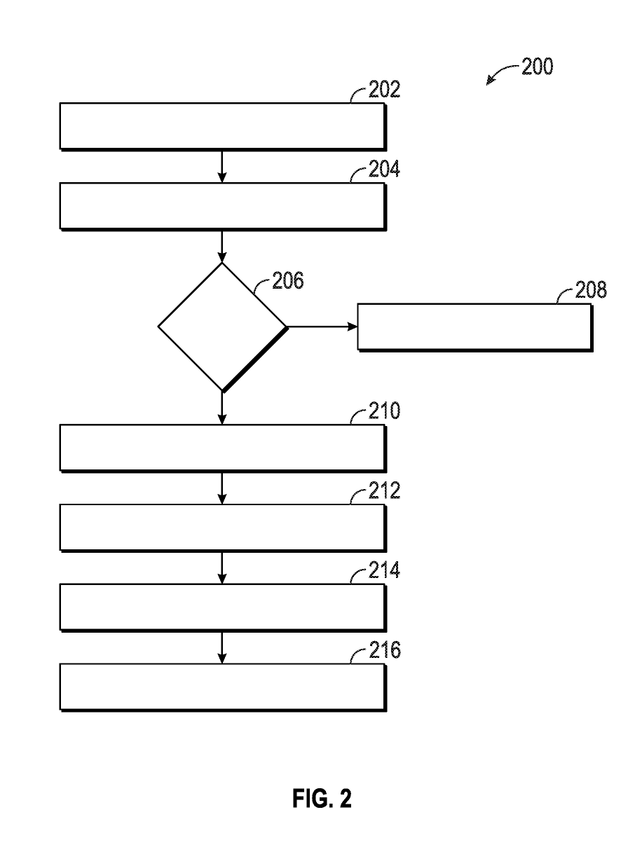

With regard to the above-referenced downforce elements 101, in various embodiments the downforce elements 101 may comprise one or more wings, airfoils, spoilers, vents, and/or other devices that are configured to increase or decrease airflow based on control by the control system 102. In certain embodiments, the downforce elements 101 are mechanically operated and/or adjusted via the control system 102, for example by moving the downforce elements 101 into a different position, angle, or pitch, and/or by opening or closing a vent or other feature of the downforce elements 101. As depicted in FIG. 2, in various embodiments the downforce elements 101 may be formed from, within, against, or inside the body 114 of the vehicle 100 at any number of locations of the vehicle 100, for example in the front of the vehicle 100, in the back of the vehicle 100 (e.g. one or more front airfoils 151), in the rear of the vehicle 100 (e.g. one or more rear spoilers 152), on one or more sides of the vehicle 100 (e.g. one or more sets of wings 153), and/or within or underneath the body 114 (e.g. one or more vents 154 underneath the vehicle 100). It will be appreciated that the number, type, and/or location of the downforce elements 101 may vary in different embodiments. For example, in certain embodiments, the vehicle 100 may include a single downforce element 101. In other embodiments, the vehicle 100 may include multiple downforce elements 101, such as certain of the downforce elements 101 depicted in FIG. 1 and/or other downforce elements 101.

As noted above, the control system 102 controls downforce for the vehicle 100. In various embodiments, the control system 102 controls the downforce via actuation of and/or other control over one or more of the downforce elements 101, for example as discussed further below in greater detail in connection with the process 200 of FIG. 2. In one embodiment, the control system 102 is mounted on the chassis 112.

As depicted in FIG. 1, in one embodiment the control system 102 comprises various sensors 104 (also referred to herein as a sensor array) and a controller 106. The sensors 104 include various sensors that provide measurements for use in controlling the downforce for the vehicle 100. In the depicted embodiment, the sensors 104 include one or more force sensors 162, pressure sensors 164, temperature sensors 166, height sensors 168, and angle sensors 170.

The force sensors 162 measure a load on one or more of the tires 117 and/or a downforce on one or more of the tires 117, wheels 116, and/or axles 135, 136. In various embodiments, force sensors 162 are disposed on, against, or proximate each of the axles 135, 136. In addition, in certain embodiments, force sensors 162 are disposed on, against, or proximate each of the tires 117 and/or wheels 116. Also in various embodiments, measurements from the force sensors 162 are provided to the control system 106 for processing, and for controlling downforce for the vehicle 100.

The pressure sensors 164 measure a pressure of one or more of the tires 117. In various embodiments, pressure sensors 164 are disposed on, against, or proximate each of the tires 117. Also in various embodiments, measurements from the pressure sensors 164 are provided to the control system 106 for processing, and for controlling downforce for the vehicle 100.

The temperature sensors 166 measure a temperature of one or more of the tires 117. In various embodiments, temperature sensors 166 are disposed on, against, or proximate each of the tires 117. Also in various embodiments, measurements from the temperature sensors 166 are provided to the control system 106 for processing, and for controlling downforce for the vehicle 100.

The height sensors 168 measure a ride height of the vehicle 10. In various embodiments, one or more height sensors 168 (also referred to as chassis position sensors) are disposed within or proximate one or more of the wheels 116. Also in various embodiments, measurements from the height sensors 168 are provided to the control system 106 for processing, and for controlling downforce for the vehicle 100.

The angle sensors 170 measure one or more angles pertaining to the vehicle. In certain embodiments, the angle sensors 170 measure a bank angle for a road or path on which the vehicle 100 is travelling. In various embodiments the angle sensors 170 comprise accelerometers that measure the angles of the vehicles via acceleration measurements. In various embodiments the angle sensors 170 comprise or are part of the inertial measurement unit (IMU). Also in various embodiments, measurements from the angle sensors 170 are provided to the control system 106 for processing, and for controlling downforce for the vehicle 100.

The controller 106 is coupled to the sensors 104 and to the downforce elements 101. The controller 106 utilizes information from the sensors 104 to control downforce for the vehicle 100, such as described further below in connection with the process 200 depicted in FIG. 2.

As depicted in FIG. 1, the controller 106 comprises a computer system. In certain embodiments, the controller 106 may also include one or more of the sensors of the sensors 104, one or more other devices and/or systems, and/or components thereof. In addition, it will be appreciated that the controller 106 may otherwise differ from the embodiment depicted in FIG. 1. For example, the controller 106 may be coupled to or may otherwise utilize one or more remote computer systems and/or other systems, such as the steering system 150, the braking system 160, and/or the electronic control system 118 of the vehicle 100, and/or one or more other systems of the vehicle 100.

In the depicted embodiment, the computer system of the controller 106 includes a processor 172, a memory 174, an interface 176, a storage device 178, and a bus 180. The processor 172 performs the computation and control functions of the controller 106, and may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs contained within the memory 174 and, as such, controls the general operation of the controller 106 and the computer system of the controller 106, generally in executing the processes described herein, such as those described further below in connection with FIG. 2.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores the above-referenced program 182 along with one or more stored values 184 (e.g. threshold values used for controlling downforce in the vehicle 100).

The bus 180 serves to transmit programs, data, status and other information or signals between the various components of the computer system of the controller 106. The interface 176 allows communication to the computer system of the controller 106, for example from a system driver and/or another computer system, and can be implemented using any suitable method and apparatus. In one embodiment, the interface 176 obtains the various data from the sensors of the sensors 104. The interface 176 can include one or more network interfaces to communicate with other systems or components. The interface 176 may also include one or more network interfaces to communicate with technicians, and/or one or more storage interfaces to connect to storage apparatuses, such as the storage device 178.

The storage device 178 can be any suitable type of storage apparatus, including direct access storage devices such as hard disk drives, flash systems, floppy disk drives and optical disk drives. In one exemplary embodiment, the storage device 178 comprises a program product from which memory 174 can receive a program 182 that executes one or more embodiments of one or more processes of the present disclosure, such as the steps described further below in connection with FIG. 2. In another exemplary embodiment, the program product may be directly stored in and/or otherwise accessed by the memory 174 and/or a disk (e.g., disk 186), such as that referenced below.

The bus 180 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 106 may also otherwise differ from the embodiment depicted in FIG. 1, for example in that the computer system of the controller 106 may be coupled to or may otherwise utilize one or more remote computer systems and/or other systems.

It will be appreciated that the vehicle 100 can be operated in an automated manner by commands, instructions, and/or inputs that are “self-generated” onboard the vehicle itself. Alternatively or additionally, the vehicle 100 can be controlled by commands, instructions, and/or inputs that are generated by one or more components or systems external to the vehicle 100, including, without limitation: other vehicles; a backend server system; a control device or system located in the operating environment; or the like. In certain embodiments, therefore, the vehicle 100 can be controlled using vehicle-to-vehicle data communication, vehicle-to-infrastructure data communication, and/or infrastructure-to-vehicle communication, among other variations (including partial or complete control by the driver or other operator in certain modes, for example as discussed above).

With reference to FIG. 2, a flowchart is provided for a process 200 for controlling downforce in a vehicle, in accordance with an exemplary embodiment. The process 200 may be implemented in connection with the vehicle 100 of FIG. 1, including the downforce elements 101 and the control system 102 thereof, in accordance with various embodiments.

As depicted in FIG. 2, the process 200 begins at step 202. In one embodiment, the process 200 begins when a vehicle is in operation, for example, when the vehicle is in a “drive mode”, moving along a path or roadway, and/or ready for movement along a desired path.

An initial downforce target is obtained (step 202). In one embodiment, the initial downforce target comprises a standard or default value of downforce for the vehicle. Also in one embodiment, the initial downforce target is stored in the memory 182 of FIG. 1 as one of the stored values 184 thereof prior to the current ignition cycle or vehicle drive (e.g. during manufacturing, or during configuration for racing or other performance features, among other possible configurations). Also in one embodiment, the initial downforce target comprises a default value under average, normal, or typical conditions, and/or in the absence of other parameter data. In addition, in certain embodiments, separate initial downforce targets are obtained for the front versus rear axles 135, 136. In certain embodiments, the initial downforce targets include separate initial maximum downforce target values for the front and rear axles 135, 136. In various embodiments, initial downforce targets are established via one or more techniques that are state based, derived from driver inputs, derived via vehicle responses, and/or one or more, or all, of the above.

Various data is obtained pertaining to parameters for the vehicle (step 204). In various embodiments, the data includes various information, measurements, and other data from the sensors 104 of FIG. 1 pertaining to parameters pertaining to the vehicle 100, the operation thereof, and/or the roadway or path on which the vehicle 100 is travelling. In one embodiment, the data of step 204 includes the load on one or more of the tires 117 (e.g. as measured via the force sensors 162), the pressure for one or more of the tires 117 (e.g. as measured via the pressure sensors 164), the temperature for one or more of the tires 117 (e.g. as measured via the temperature sensors 166), a ride height for the vehicle 100 (e.g. as measured via one or more of the height sensors 168), and a bank angle of the vehicle (e.g. as measured via the angle sensors 170). In addition, in certain embodiments, data is also obtained regarding one or more vehicle faults pertaining to vehicle dynamics, for example as determined via the steering system 150, the braking system 160, the ECS 118, the control system 102, and/or one or more other vehicle systems (e.g., as communicated via the vehicle bus 107 and/or the wireless system 108 from such other systems to the control system 102).

A determination is made as to whether a change in in downforce for the vehicle is desired (step 206). In one embodiment, the determination includes at least a determination as to whether a reduction in downforce (also known in the industry as “load shedding” is desired). In one embodiment, the determination of step 206 is based on various parameter values from step 204, including the load on one or more of the tires 117, the pressure for one or more of the tires 117, the temperature for one or more of the tires 117, a ride height for the vehicle 100, a bank angle of the vehicle, and/or data regarding one or more vehicle faults pertaining to vehicle dynamics. In various embodiments, the various different parameter values are combined together to ascertain one or more combined effects of the parameter values, and their resulting aggregate impact on the desired downforce for the vehicle 100.

For example, in one embodiment, if the tire load exceeds a predetermined threshold, then a decrease in downforce is desired. Also in one embodiment, a decrease in downforce is also desired if the tire pressure exceeds a predetermined threshold. In one embodiment, a decrease in downforce is also desired if the tire temperature exceeds a predetermined threshold. In addition, in one embodiment, a decrease in downforce is also desired if the ride height is less than a predetermined value. Also in one embodiment, a decrease in downforce is also desired if the bank angle represents a sharp angle for turning the vehicle 100. In addition, in one embodiment, a decrease in downforce is also desired if one or more dynamic vehicle faults are determined to have occurred. In one embodiment, all of the values are considered, and the lowest value is selected or taken. In various embodiments, the determination(s) of step 206 are made via the processor 172 of FIG. 1.

If it is determined in step 206 that a downforce adjustment is not desired, then downforce adjustment is made (step 208). Specifically, in one embodiment, during step 208, no change is made to the downforce elements 101 of FIG. 1, and the vehicle 100 continues to operate in accordance with the initial downforce target of step 202.

Conversely, if it is determined in step 206 that a downforce adjustment is desired, then an updated downforce target is determined (step 210). In one embodiment, during step 210, the downforce target is updated upward or downward from the initial target of step 202, based on the combination of the effects of the various parameter values of step 204. For example, in one embodiment, the target is adjusted downward if the tire load exceeds a predetermined threshold, the tire pressure exceeds a predetermined threshold, the tire temperature exceeds a predetermined temperature, the ride height is less than a predetermined value, the bank angle represents a sharp angle for turning the vehicle 100, and/or one or more dynamic vehicle faults are determined to have occurred. Also in certain embodiments, the target may be adjusted upward based on opposite values of the one or more parameters (e.g. if the tire load is less than its predetermined threshold, the tire pressure is less than its predetermined threshold, the ire temperature is less than its predetermined threshold, the ride height is less than its predetermined value, the bank angle represents a more gradual angle, and there are no dynamic vehicle faults determined to have occurred). In addition, in certain embodiments, separate downforce target adjustments are made for the front versus rear axles 135, 136, for example based on different parameter values (e.g., tire load, tire pressure, tire temperature, and/or ride height) as measured on the front axle 135 versus the rear axle 136. In addition, in certain embodiments, the updated target adjustments include separate maximum downforce target values for the front and rear axles 135, 136. In various embodiments, the downforce target is updated by the processor 172 of FIG. 1.

A front and rear balance of the vehicle is adjusted (step 212). In one embodiment, a balance between the front and rear of the vehicle 100 is adjusted by the processor 172 of FIG. 1 based on the updated downforce target of step 210. Specifically, in one embodiment, the change in the downforce target is effectively distributed between the front and rear axles 135, 136 of the vehicle 100. In one such embodiment, the change in the downforce target is effectively distributed equally between the front and rear axles 135, 136. In another embodiment in which separate downforce targets are updated for the front and rear axles 135, 136 in step 210, a minimum function block is used with respect to whichever axles 134 (e.g. the front axle 135 or the rear axle 136) reaches its downforce limit first

A desired position or adjustment of one or more downforce elements is determined (step 214). In various embodiments, the processor 172 of FIG. 1 determines a desired position or adjustment of one or more of the downforce elements 101 of FIG. 1 (for example, one or more front airfoils 151, rear spoilers 152, wings 153, and/or vents 154) in order to attain desired downforce adjustments for the vehicle 100 (e.g. for the front axle 135, the rear axle 136, or both) to attain the desired updated downforce target and front/rear balance of step 210 and 212. In various embodiments, the desired position or adjustment may pertain to a change in position, an end position, or both, of the respective downforce elements (101) (e.g. a change in angle, amount of opening, physical location, and so on), and/or a particular action (e.g. by an actuator, valve, or other device) that may be controlled by the processor 172 for obtaining this desired result.

The desired position or adjustment of the one or more downforce elements is then implemented (step 216). In various embodiments, the processor 172 of FIG. 1 causes a change in angle, movement, opening or closure, or other change in angle, position, or status of the respective downforce elements 101 in order to achieve the desired position or adjustment of step 214. In various embodiments, the controller 106 controls one or more actuators, vents, and/or other control mechanisms for adjustment of the respective downforce elements 101 in this manner (e.g. by adjusting an angle or position of one or more front airfoils 151, rear spoilers 152, and/or wings 153, and/or opening or closing one or more vents 154, among other potential actions, such as controlling any or all actively controlled surfaces) in accordance with various embodiments).

Accordingly, methods, systems, and vehicles are provided that control the downforce for vehicles, such as for racecars or other performance vehicles. In various embodiments, the downforce is adjusted by actuation of one or more downforce elements (e.g. one or more front airfoils 151, rear spoilers 152, wings 153, and/or vents 154) based on vehicle-related parameters such as tire pressure, tire temperature, ride height, bank angle, and/or any detected dynamic vehicle faults). Such methods, systems, and vehicles can be advantageous, for example, by optimizing the vehicle downforce based on different dynamic aspects of a particular vehicle drive or ignition cycle (e.g. by providing increased downforce when best utilized during a sharp turn, and reducing downforce when appropriate such as to reduce drag, and so on). Also as a result, in certain embodiments the maximum downforce values may be increased, as compared with other vehicles in which the vehicle downforce may not be adjusted during the vehicle drive or ignition cycle.

It will be appreciated that the disclosed methods, systems, and vehicles may vary from those depicted in the Figures and described herein. For example, the vehicle 100, the downforce elements 101, the control system 102, and/or various components thereof may vary from that depicted in FIG. 1 and described in connection therewith. It will similarly be appreciated that the process 200 may differ from that depicted in FIG. 2, and/or that one or more steps may occur simultaneously or in a different order than depicted in FIG. 2, among other possible variations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method comprising:
obtaining one or more parameter values for a vehicle during operation of the vehicle; and
adjusting a downforce for the vehicle, during operation of the vehicle, based on the one or more parameter values, using instructions provided via a processor for controlling one or more downforce elements for the vehicle.

2. The method of claim 1, wherein:
the step of obtaining the one or more parameter values comprises measuring a tire load for one or more tires of the vehicle via a sensor onboard the vehicle; and
the step of adjusting the downforce comprises adjusting the downforce for the vehicle, during operation of the vehicle, based on the tire load, using instructions provided via the processor in controlling the one or more downforce elements for the vehicle.

3. The method of claim 1, wherein:
the step of obtaining the one or more parameter values comprises measuring a tire pressure for one or more tires of the vehicle via a sensor onboard the vehicle; and
the step of adjusting the downforce comprises adjusting the downforce for the vehicle, during operation of the vehicle, based on the tire pressure, using instructions provided via the processor in controlling the one or more downforce elements for the vehicle.

4. The method of claim 1, wherein:
the step of obtaining the one or more parameter values comprises measuring a tire temperature for one or more tires of the vehicle via a sensor onboard the vehicle; and
the step of adjusting the downforce comprises adjusting the downforce for the vehicle, during operation of the vehicle, based on the tire temperature, using instructions provided via the processor in controlling the one or more downforce elements for the vehicle.

5. The method of claim 1, wherein:
the step of obtaining the one or more parameter values comprises measuring a ride height for the vehicle via a sensor onboard the vehicle; and
the step of adjusting the downforce comprises adjusting the downforce for the vehicle, during operation of the vehicle, based on the ride height, using instructions provided via the processor in controlling the one or more downforce elements for the vehicle.

6. The method of claim 1, wherein:
the step of obtaining the one or more parameter values comprises measuring a bank angle for a path on which the vehicle is travelling via a sensor onboard the vehicle; and
the step of adjusting the downforce comprises adjusting the downforce for the vehicle, during operation of the vehicle, based on the bank angle, using instructions provided via the processor in controlling the one or more downforce elements for the vehicle.

7. The method of claim 1, wherein:
the step of obtaining the one or more parameter values comprises determining whether one or more faults pertaining to dynamic operation of the vehicle have occurred via one or more vehicle systems; and
the step of adjusting the downforce comprises adjusting the downforce for the vehicle, during operation of the vehicle, based on whether the one or more faults have occurred, using instructions provided via the processor in controlling the one or more downforce elements for the vehicle.

8. The method of claim 1, wherein the step of adjusting the downforce comprises:
obtaining an initial downforce target;
generating an updated downforce target using the initial downforce target and the one or more parameter values;
determining a front/rear balance adjustment associated with the updated downforce target; and
controlling the one or more downforce elements based at least in part on the updated downforce target and the front/rear balance adjustment.

9. The method of claim 1, wherein the step of adjusting the downforce comprises adjusting the downforce based at least in part on separate measurements of the one or more parameter values on a front axle and a rear axle of the vehicle.

10. The method of claim 9, wherein the step of adjusting the downforce comprises adjusting the downforce based at least in part on respective maximum downforces for the front axle and the rear axle.

11. A system comprising:
one or more sensors configured to measure one or more parameter values for a vehicle during operation of the vehicle; and
a processor coupled to the one or more sensors, the processor configured to at least facilitate adjusting a downforce for the vehicle, during operation of the vehicle, based on the one or more parameter values, by providing instructions for controlling one or more downforce elements for the vehicle.

12. The system of claim 11, wherein:
the one or more sensors are configured to measure a tire load for one or more tires of the vehicle via a sensor onboard the vehicle; and
the processor is configured to at least facilitate adjusting the downforce for the vehicle, during operation of the vehicle, based on the tire load, by providing instructions for controlling one or more downforce elements for the vehicle.

13. The system of claim 11, wherein:
the one or more sensors are configured to measure a tire pressure for one or more tires of the vehicle via a sensor onboard the vehicle; and
the processor is configured to at least facilitate adjusting the downforce for the vehicle, during operation of the vehicle, based on the tire pressure, by providing instructions for controlling one or more downforce elements for the vehicle.

14. The system of claim 11, wherein:
the one or more sensors are configured to measure a tire temperature for one or more tires of the vehicle via a sensor onboard the vehicle; and
the processor is configured to at least facilitate adjusting the downforce for the vehicle, during operation of the vehicle, based on the tire temperature, by providing instructions for controlling one or more downforce elements for the vehicle.

15. The system of claim 11, wherein:
the one or more sensors are configured to measure a ride height for the vehicle via a sensor onboard the vehicle; and
the processor is configured to at least facilitate adjusting the downforce for the vehicle, during operation of the vehicle, based on the ride height, by providing instructions for controlling one or more downforce elements for the vehicle.

16. The system of claim 11, wherein:
the one or more sensors are configured to measure a bank angle for the vehicle via a sensor onboard the vehicle; and
the processor is configured to at least facilitate adjusting the downforce for the vehicle, during operation of the vehicle, based on the bank angle, by providing instructions for controlling one or more downforce elements for the vehicle.

17. The system of claim 11, wherein the processor is configured to at least facilitate:
obtaining an initial downforce target;
generating an updated downforce target using the initial downforce target and the one or more parameter values;
determining a front/rear balance adjustment associated with the updated downforce target; and
controlling the one or more downforce elements based at least in part on the updated downforce target and the front/rear balance adjustment.

18. The system of claim 11, wherein:
the one or more sensors are configured to measure the one or more parameter values on a front axle and a rear axle of the vehicle; and
the processor is configured to at least facilitate adjusting the downforce based at least in part on separate measurements of the one or more parameter values on the front axle and the rear axle of the vehicle from the one or more sensors.

19. The system of claim 18, wherein the processor is configured to at least facilitate adjusting the downforce based at least in part on respective maximum downforces for the front axle and the rear axle.

20. A vehicle comprising:
one or more downforce elements;
one or more sensors configured to measure one or more parameter values for the vehicle during operation of the vehicle; and
a processor coupled to the one or more downforce elements and to the one or more sensors, the processor configured to at least facilitate adjusting a downforce for the vehicle, during operation of the vehicle, based on the one or more parameter values, by providing instructions for controlling the one or more downforce elements.
